(19) United States
(12) Patent Application Publication
(10) Pub. No.: US 2018/0276346 A1
(43) Pub. Date: Sep. 27, 2018

(54) Networks For Organic Reactions And Compounds

(71) Applicant: Northwestern University, Evanston, IL (US)

(72) Inventors: Bartosz A. Grzybowski, Evanston, IL (US); Kyle J.M. Bishop, Cambridge, MA (US); Bartiomiej Kowatczyk, Evanston, IL (US); Christopher E. Wilmer, Evanston, IL (US)

(21) Appl. No.: 15/958,615

(22) Filed: Apr. 20, 2018

Related U.S. Application Data
(63) Continuation of application No. 12/717,801, filed on Mar. 4, 2010, now abandoned.
(60) Provisional application No. 61/157,431, filed on Mar. 4, 2009.
(60) Provisional application No. 61/165,034, filed on Mar. 31, 2009.

(51) Int. Cl. G06F 19/00

(52) U.S. Cl. CPC G06F 19/702; G06F 19/708

(57) ABSTRACT

A method for analyzing a collection of organic chemical reactions and compounds reported in the literature in the form of a complex network in either a normal, one-mode graph or a bipartite graph is disclosed. Also disclosed are methods, algorithms, computer-readable storage mediums and other applications derived from the analysis of this graph/network theory.

This application is a continuation of U.S. patent application Ser. No. 12/717,801 filed Mar. 4, 2010, which claims priority benefit of application Ser. No. 61/157,431 filed Mar. 4, 2009 and of application Ser. No. 61/165,034 filed Mar. 31, 2009, the entirety of all of which are incorporated herein by reference.

### FIELD OF THE INVENTION

The present invention relates generally to the analysis of the entire collection of organic chemical reactions and compounds reported in the literature over the past two centuries in the form of a complex network in either normal, one-mode graph or bipartite graph representations. Specifically, the invention relates to methods, algorithms, computer-readable storage mediums and other applications derived from the analysis of this graph/network theory.

### BACKGROUND OF THE INVENTION

The synthesis of organic compounds is one of the most important and creative pursuits in modern science, requiring not only technical expertise, but also imagination, intuition and individual judgment (Tietz, L. et al., Angew. Chem. Int. Ed. Engl., 1993, 32, 131; Corey, E. J. et al., The Logic of Chemical Synthesis, Wiley-Interscience, New York, 1995; Nicolaou, K. C. et al., Angew. Chem. Int. Ed., 2000, 39, 44). Sometimes, as in the title of Nicolaou's classic review cited above, chemical synthesis is equated with art, which, by definition, reflects individual imagination and often defies convention, statistics and order. Yet, the universe of chemistry humans are collectively creating—one comprising millions upon millions of known reactions and compounds—is surprisingly well-ordered, and its evolution obeys trends that have not changed since the pioneering times of Lavoisier.

On the most abstract level, the millions of known chemicals and reactions constituting organic chemistry can be represented as a complex network, in which compounds correspond to nodes and reactions to directed connections between these nodes (R. Albert et al., Rev. Mod. Phys. 2002, 74, 47). Recently, it has been shown that such a network has a scale-free topology similar to that of the World Wide Web and that by analyzing its time evolution, it is possible to derive statistical laws that describe and also predict how and which types of molecules could be synthesized (Grzybowski, B. A. et al., Angew. Chem. Int Ed., 2005, 44, 7263). This scale-free topology has also been used to demonstrate the existence of a small set of strongly connected, chemically diverse core compounds from which the majority of other known organic compounds in the periphery can be made in three or fewer synthetic steps, and that these core compounds are surrounded by small island compounds that do not connect either to the core or to the periphery (Grzybowski, B. A. et al., Angew. Chem. Int Ed, 2006, 45, 5348). Utilizing such a network could have many applications.

Such an example is chemical warfare. With the increasing risks associated with terrorist organizations, chemical weapons might be considered an ideal mode of attack, since they are both cheap and easy to transport. In addition, many of these deadly substances can nowadays be synthesized readily from commercially available substrates and using synthetic procedures available from public sources. Indeed, the 1995 terrorist attack in the Tokyo subway was carried out with sarin synthesized by cult members using common and unregulated precursors obtained through a network of front companies. This example underscores the need to monitor chemical inventories and also purchase orders to prevent select chemicals, sometimes apparently benign, from falling into the hands of terrorist organizations.

Current methods of chemical agent control rely on static lists of “chemicals of interest.” These lists can be “flat” (for example, the list of 320 compounds compiled by the U.S. Department of Homeland Security), or multi-tiered like the 1993 CW Convention list.¹ Unfortunately, control methods based on static lists are easy to circumvent, either by developing trivially different chemical analogs, or by utilizing readily available, non-scheduled starting materials that are two or more synthetic steps away from the target compound. Moreover, static lists can only provide risk assessment, but are incapable of dealing with the concept of intent. These difficulties cannot be overcome by simple list expansion, since this would place an undue burden on legitimate chemical industry and academic research while not preventing a determined and synthetically skilled terrorist from obtaining suitable precursors (or their close analogs) under false pretense. As such, an improved method for assessing the risk and management of chemical inventories and purchases is required. ¹ http://www.opcw.org/html/db/cwc/eng/cwc_annex_on_chemicals.html

Similarly, discovery and/or design of reactions that proceed sequentially in one reaction vessel is among the holy grails of modern organic synthesis. The ability to perform multiple reactions in one reaction vessel and in a well-defined sequence can simplify and accelerate multiple-step syntheses, and can translate into significant economic savings by reducing the amounts of byproducts and by eliminating intermediate purification steps which account for as much as 60% of the total synthetic cost (see Chem. Soc. Rev. 2004, 33, 302-312; ChemSusChem 2008, 1, 718-724; Chem. Rev. 2005, 105, 1001-1020; Biotech. Lett. 2000, 22, 871-874) Therefore, the identity of such reactions is desired.

### SUMMARY OF THE INVENTION

In light of the foregoing, it is an object of the present invention to provide a computer-implemented method for analyzing a conversion of a plurality of organic chemical reactions into a projected or bipartite graph. In a normal, projected graph or representation, compounds correspond to nodes, and directed edges are assigned for a given reaction by connecting all reactants to all products. In a bipartite representation, compounds correspond to substance nodes and are connected through reaction nodes by directed edges. Such a method of analysis makes it possible to derive statistical laws that describe and also predict how and which types of molecules could be synthesized, and which new reactions could be developed.

As such, it is further an object of the invention to provide a computer-implemented method of monitoring an organic compound or compounds of interest by analyzing such a conversion of a plurality of organic chemical reactions into a projected or bipartite graph.

It is yet another object of the invention to provide a computer-implemented method of economically optimizing multiple reactions in parallel by analyzing such a conversion of a plurality of organic chemical reactions into a projected or bipartite graph.

It is still another object of the invention to provide a computer-implemented method of automatically identifying reactions that can be performed sequentially by analyzing such a conversion of a plurality of organic chemical reactions into a projected or bipartite graph.

Accordingly, it will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

Other objects, features, benefits and advantages of the present invention will be apparent from this summary and the following descriptions of certain embodiments, and will be readily apparent to those skilled in the art. Such objects, features, benefits and advantages will be apparent from the above as taken into conjunction with the accompanying examples, data, and all reasonable inferences to be drawn therefrom.

### BRIEF DESCRIPTION OF THE DRAWINGS

FIG. 1 depicts the conversion of reactions into either projected or bipartite network representations.

FIG. 2 a block diagram of exemplary embodiment of a processing system for displaying the methods of the invention.

FIG. 3 is an example of a bipartite graph depicting the two partitions.

FIG. 4 shows an example of how a bipartite graph of compounds and reactions can measure topological network indices.

FIG. 5 depicts the network of chemistry in the years 1835, 1840 and 1845.

FIG. 6 shows the major topological components of the chemistry network, i.e. the core, the periphery and the islands in the year 1840.

FIG. 7 shows examples of (a) synthetic pathways and (b) synthetically challenging molecules identified by network analysis.

FIG. 8 depicts how the in- and out-connectivity distributions of molecules in the network obey a power law P(k)˜k^{γ} characteristic of scale-free networks.

FIG. 9 is a schematic illustration of the preferential attachment mechanism responsible for chemistry's scale-free topology.

FIG. 10 depicts the frequency distributions of masses of molecules that were used as substrates and products in reactions reported in 25-year intervals between 1850 and 2004.

FIG. 11 shows examples of minimal sets (circled) for the same bipartite graph.

FIG. 12 depicts minimal sets and their topological indices in relation to the production of a compound.

FIG. 13 depicts the network-based monitoring of specific restricted compounds in accordance with the invention.

FIG. 14 shows an example of an output of a minimal set search of mustard gas.

FIG. 15 is schematic illustration of the network optimization method, both a (a) topological view.

FIG. 16 shows three examples of potential sequential chemical reactions identified by the network.

### DETAILED DESCRIPTION OF THE INVENTION

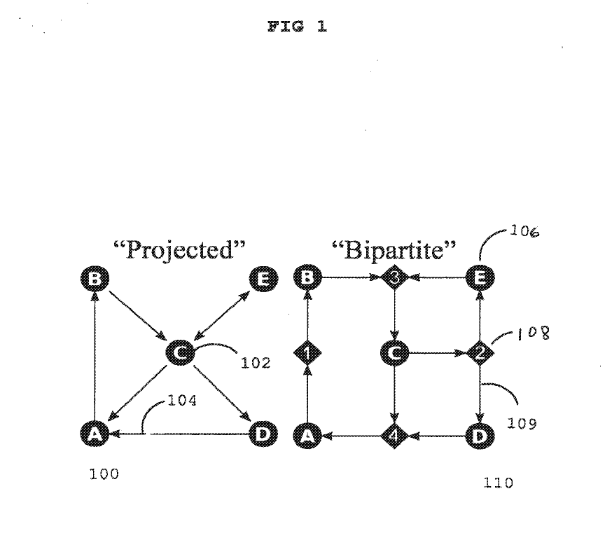

Illustrating certain non-limiting aspects and embodiments of this invention, a computer-implemented method for analyzing a translation of a plurality of organic chemical reactions retrieved from a database to a projected graph 100 or bipartite graph 110 or network is disclosed. In a projected network 100 of the method, the molecules are nodes 102 and the reactions are the arrows 104 connecting them (FIG. 1). In a bipartite network 110 of the method, nodes are divided into two disjoint sets, compounds 106 and reactions 108, such that every edge 109 connects a compound node to one in a reaction mode (FIG. 1).

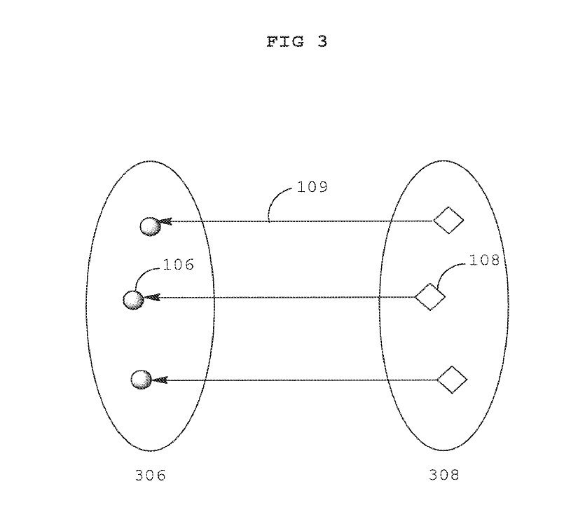

In a specific embodiment and referring to FIGS. 1-3, the method comprises constructing a bipartite graph 110 from a set of data 210, comprising obtaining the set of data 200 from a database 220, the set of data 200 comprising a set of organic compounds 206 and a set of reactions 208; inputting the set of data 210 into a computer readable storage unit 230 coupled to one or more processors 240; configuring the processor 240 to partition the set of data 210 into a first partition 306 and a second partition 308, wherein the first partition 306 comprises a first set of nodes 106, wherein each node of the first set of nodes 106 represents an organic compound, and wherein the second partition 308 comprises a second set of nodes 108, wherein each node of the second set of nodes 108 is a reaction, and wherein each organic compound node 106 is connected to one or more reaction nodes 108 by a directed edge 109 (FIG. 3); and deriving and storing in volatile or non-volatile memory the bipartite graph 110 associating the set of first nodes 106 with the set of second nodes 108.

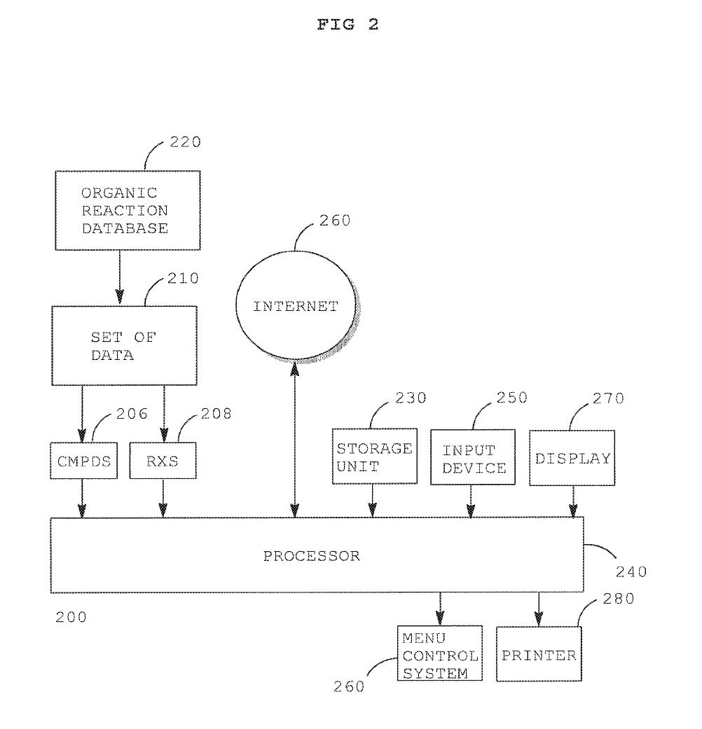

Referring now to the drawings in detail wherein like numbers represent like elements throughout, FIG. 2 illustrates an exemplary embodiment of a processor system 200 configured to implement the methods of the invention disclosed herein. A processing unit 240, for example, is a mainframe or a server coupled to an array of peripherals or a desktop computer or a laptop computer. Coupled to the processor is one or more databases 220 which may themselves be coupled to additional processors.

In FIG. 2, a database of organic reactions 220 provides a set of data 210 to the processor 240. Such data 240 can be provided by an input drive 250, coupled to the processor 240, or through an internet network 260 connection, either by hardwired or wireless devices. The data 210 is stored in a computer readable storage unit coupled 230 to the processor 240 and manipulated by a menu control system 260 coupled to the processor 240. As stated, the processor typically includes an input device 250, for example a mouse, or a keyboard, and a display device 270, for example a monitor screen or a smart phone. Such devices can be hardwired to the processor or connected wirelessly with appropriate software, firmware and hardware. The display device 270 may also include a printer 280 coupled to the processor 240. The printer 280 may be configured to mail or fax reports as determined by a user of the processor system 200.

The network is constructed from a database or databases that stores published organic chemical reactions. For example, Crossfire Beilstein Database (BD, Elsevier Informations Systems) is the largest repository of organic reactions (see Grzybowski, B. A. et al., Angew. Chem. Int Ed., 2005, 44, 7263; Grzybowski, B. A. et al., Angew. Chem. Int Ed, 2006, 45, 5348; and Grzybowski, B. A. et al., Nature Chemistry, 2009, l, 31, all of which are incorporated herein by reference). In choosing BD, the well-established criterion for the classification of chemical substances as “organic” and its comprehensive coverage of the chemical literature dating back to 1779 is adopted. While BD is not without omissions (for example, it reports only select types of polymer and is not a comprehensive repository of proteins, DNA, or many important non-covalent organic architectures), it provides the single, most complete description of organic chemistry and its evolution. A processor is coupled to the database. The processor is configured to prune the database to remove catalysts, solvents, substances that participate in no reactions, duplicate reactions, and reactions that lack either reactants or products (that is, half reactions), leaving a universe of known organic chemistry comprising some 6.5 million substances and about 7.0 million reactions connecting them. In the translation of organic synthesis into a network of chemical connectivity, each compound node is represented by some characteristic of the compound, such as, for example, its molecular mass (99.7% of the compounds in BD have mass data).

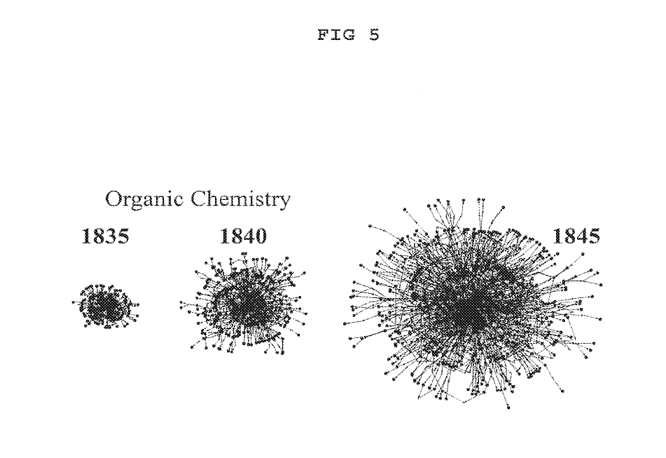

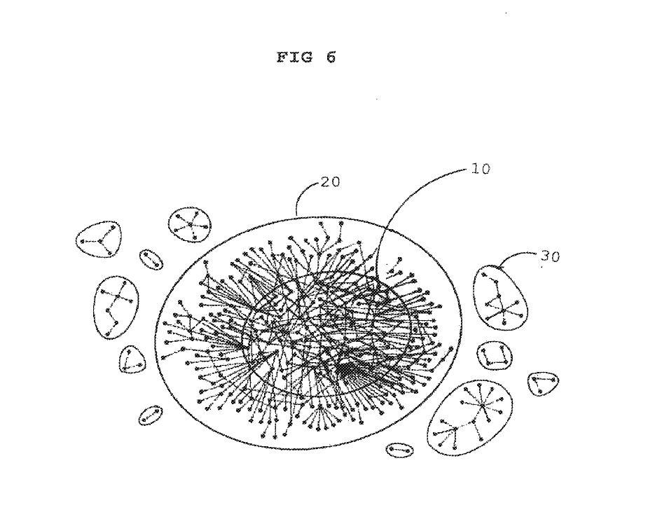

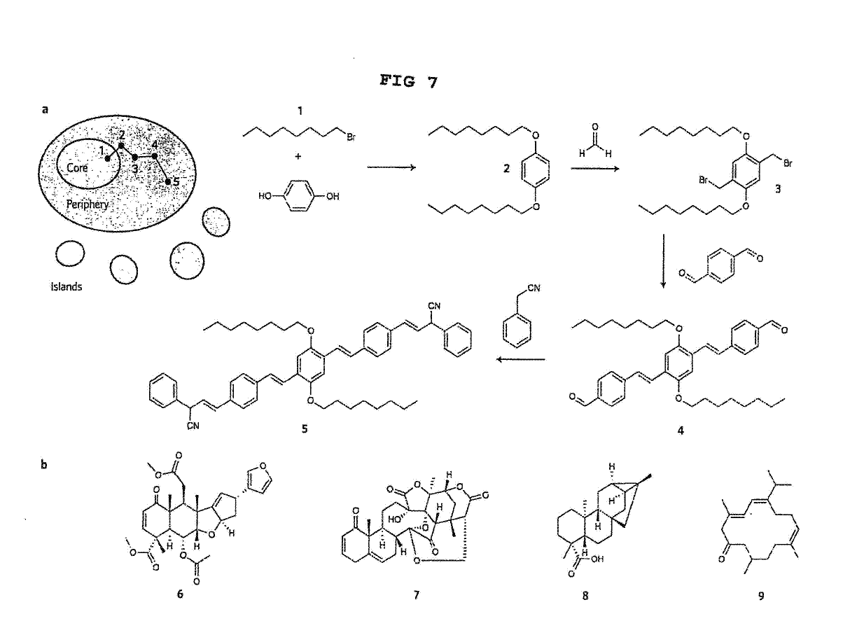

Beginning with the entries from the first years of the 1800s, both the numbers of molecules and the numbers of chemical reactions have been increasing exponentially to create a network whose complexity exceeds that of metabolic networks and rivals that of the World Wide Web. Despite its apparent randomness (FIG. 5), this network has a well-defined, modular architecture and three distinct regions: the core 10, the periphery 20 and the islands 30 (FIGS. 6 and 7).

With respect to FIG. 6, the core 10 is the subset of chemistry defined such that any two of its members can be connected by a synthetic path. The core molecules 10 are structurally diverse, relatively small (MW_{avg}=265 g/mol versus MW_{avg}=364 g/mol for molecules outside of it), and include many useful synthetic building blocks and important industrial chemicals (of the top 200, over 70% are found therein). Although they constitute only about 4% of all organic compounds, the core molecules 10 are involved in over 35% of known reactions, and give rise to more than 78% (˜5 million) of the known organic universe. Remarkably, an optimized set of as few as 300 core molecules (including chemicals for various functionalization schemes, heterobifunctional reagents, protective-group-introducing agents, important natural products, biological molecules and more) leads to over 1.5 million other compounds.

The region in the network outside of the core can be subdivided into a large periphery 20 (FIG. 6), containing molecules that can be synthesized from the core's substrates, and into smaller, isolated islands 30, not reachable from the core 10. The periphery 20 is rather loosely wired (on average ˜2.3 connections per molecule) but constitutes about 78% of chemistry, most of which is in close proximity to the core 10. Indeed, the average distance from the core 10 to any molecule in the periphery 20 is only three steps, with 95% of the peripheral substances 20 lying within seven steps from the core 10. Moving away from the core 10, the average mass/complexity of molecules increases linearly with distance (measured in synthetic steps; FIG. 5a) before leveling off to just over 700 g/mol after 15 steps (that is, after reaching over 99% of the periphery 20).

Finally, unconnected to the core/periphery are the network's islands 30, which are typically small (less than four molecules on average) but together constitute about 18% of the network. The most connected molecules in each island 30 are usually either complex natural products or specialized substances (for example, non-natural isotopes). While some islands 30 reflect imperfections of the database and its failure to report the existing syntheses connecting island molecules to the rest of chemistry, a sizeable fraction corresponds to substances that are difficult synthetic targets whose total syntheses have not yet been reported despite numerous attempts (FIG. 5b).

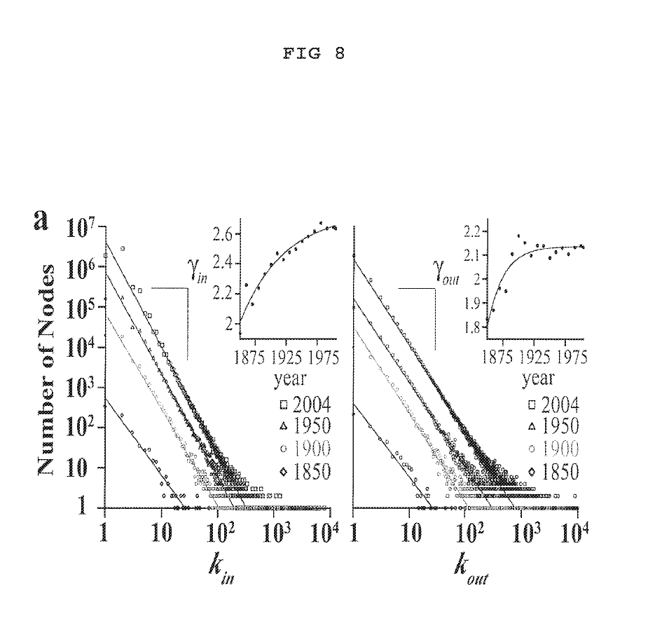

Within the general framework above, the architecture of the network is further characterized by local connectivity measures. In particular, the number of reaction arrows emanating from each node, kₒᵤₜ, corresponds to the number of times a given molecule is used as a reaction substrate (redundancy), and the number of reaction arrows pointing towards the nodes, kᵢₙ, corresponds to the number of times a molecule is used as reaction product (betweenness) (FIG. 1). Counting these connectivities for all molecules, the frequencies, P(kₒᵤₜ) and P(kᵢₙ), are plotted with which molecules of given kₒᵤₜ or kᵢₙ connectivity appear in the network. The end result of this operation is illustrated in FIG. 8, which shows that these frequencies decay algebraically as P(kₒᵤₜ)∝kₒᵤₜ^{-γout} and P(kᵢₙ)∝kᵢₙ^{-γin}.

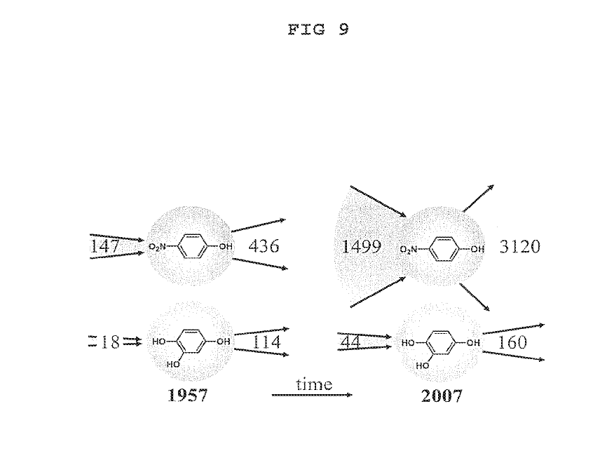

Although this scaling might not seem very illuminating, it implies that chemistry has the so-called scale-free structure (Albert, R. et al., Rev. Mod. Phys. 2002, 74, 47) similar to that of the World Wide Web, the Internet, metabolic networks, and even societies. This scale-free architecture is akin to a fractal in the sense that the structural/connectivity motifs characterizing the entire network repeat themselves in all of its subnetworks. Another distinguishing feature of being scale-free is the presence of highly connected “hub” molecules directly analogous to the hubs of the airline system (Atlanta, Chicago, London, Frankfurt and so on) facilitating transportation from one poorly connected airport to another. Likewise, in organic chemistry, the synthesis of one molecule from another by a series of chemical transformations will probably use one or more of these versatile hub compounds as intermediates. Also, the fact that the scale-free structure is conserved as the network evolves in time indicates that it grows by the mechanism of preferential attachment, whereby highly connected substances are more likely to participate in new reactions than poorly connected compounds. The more times a molecule is previously used as a synthetic substrate, i.e. the larger its kₒᵤₜ, the higher the chances it will be used again in the future. Similarly, the higher its kᵢₙ, the more likely it is that chemists will try to make it by a new reaction. Colloquially speaking, molecular “celebrities” such as p-nitrophenol are becoming ever more popular (FIG. 9), with 583 total connections in 1957 to 4,619 total connections in 2007. To the contrary, less popular molecules such as 1,2,4-trihydroxybenzene incorporate new connections less rapidly, growing from 132 to only 204 over the same period.

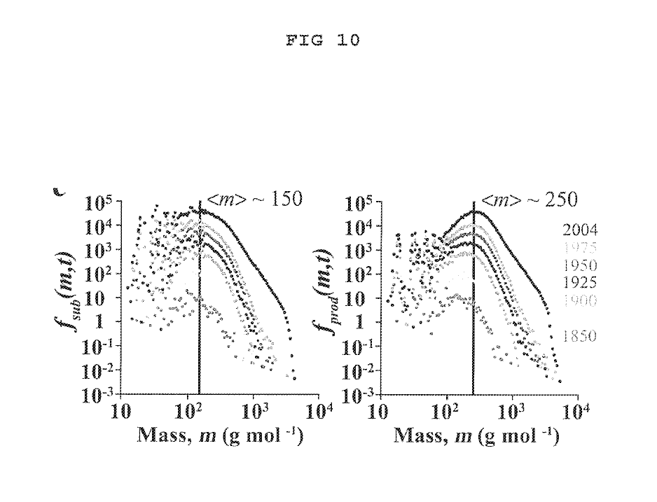

As such, simple molecular descriptors (mass, degree of unsaturation, number of stereocenters and so on) are analyzed relatively easily. Analysis of molecular masses offers some interesting insights. For example, despite the enormous progress in the synthetic methodology since the times of Hofmann and Perkin, the most commonly used substrates and products remain those of molecular weights MW_{subst}≈150 g/mol and MW_{prod}≈250 g/mol, respectively (FIG. 8). FIG. 10 shows the frequency distributions of masses of molecules that were used as substrates (f_{sub}(m, t) and products (f_{proc}(m, t) in reactions reported in 25-year intervals between 1850 and 2004. Moreover, as these most popular substrates/products correspond to the most rapidly connecting nodes of the network, the preferential attachment mechanism discussed previously predicts that these substances will remain the most popular ones in the future.

A related observation is that the shapes of the mass distributions in FIG. 10 do not change with time but only shift “upwards”. This self-similarity is an indication that the creation of new masses/molecules is based on some iterative (self-repeating) growth process. Indeed, stochastic modelling (Grzybowski, B. A. et al., Angew. Chem. Int Ed., 2005, 44, 7263) of how the molecular masses in the network of chemistry evolve allows one to back-track this process and, after some voluminous mathematics, reduce it to a surprisingly simple relationship between the masses of reaction substrates, mₛ, and products, mₚ=amₛ+b, where a and b are stochastic, i.e. drawn from an appropriate probability distribution, variables with mean values 0.67 and 180 g/mol, respectively. This stochastic equation is statistical in nature, that is, it might not work for a specific reaction, but its accuracy improves with increasing numbers of reactions considered. Although such a statistical law might be of no value to an individual chemist working on a specific reaction, its long-term and/or large-scale predictability can benefit the chemical industry in cases such as combinatorial synthesis, where the mass-evolution equation can predict the distributions of masses in compound libraries from the masses of substrates used to create these libraries.

### Monitoring of Molecules

In light of the foregoing, an embodiment of the invention is a computer-implemented method for monitoring organic compounds, the method comprising translating a plurality of organic chemical reactions to a projected or bipartite graph, wherein compounds within the graph correspond to substance nodes and are connected by directed edges representing reactions (projected) or by directed edges through reaction nodes (bipartite); selecting a target compound or compounds within the graph; running a reverse depth-first search or searches outward from the target compound or compounds to identify all possible synthetic pathways of the target compound; measuring topological graph or network indices of a precursor compound or compounds of the target compound as a result of the reverse depth-first search; and ranking the precursor compounds to the target compound using the topological indices to determine which precursor compounds are more likely to be used to make the target compound.

Alternatively, the method comprises running a combinatorial breadth-first search outward from the target compound to identify all minimal sets of precursor compounds; measuring extended topological graph or network indices of the minimal sets as a result of the combinatorial breadth-first search; and ranking the minimal sets to the target compound using the topological indices to determine which are more likely to be used to make the target compound. In another embodiment, the method comprises running both an outward, reverse DFS and an outward combinatorial breadth-first search.

In a specific embodiment, the method can be used to identify synthetic routes to controlled substances, such as, for example, narcotics and chemical weapons. By identifying such synthetic routes, one can monitor the combined inventories of chemical suppliers for the purchases of “red-flag sets” of precursor compounds that signal the intent to make controlled substances. In such an embodiment, the search or searches are preferably run from a bipartite representation, since such a representation provides for information of, for example, multiple precursors for one reaction path.

Examples of topological graph indices, topological network indices, and extended topological graph or network indices include, but are not limited to, synthetic distance, betweenness, redundancy and selectivity. The method can employ from one up to all of these indices to monitor target compounds.

By “synthetic distance” is meant the numbers of reaction nodes separating a substrate or substrates from a target. Here, the premise is that the closer a substance is synthetically to a target compound, the higher its risk for being used in malicious activity.

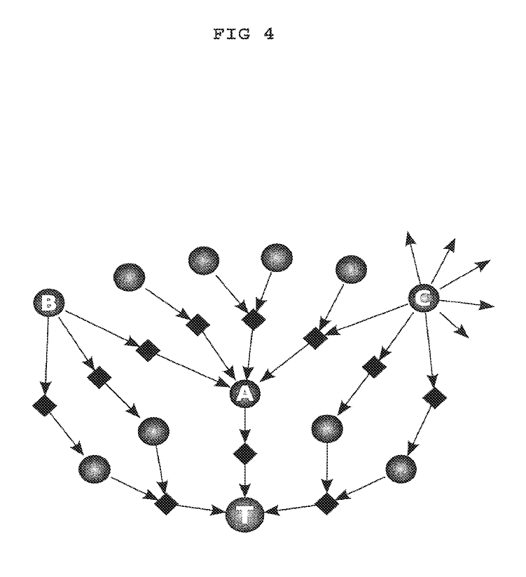

“Betweenness” is based on the so-called “betweenness centrality” of a node/molecule and refers to the number of synthetic pathways, e.g. of length up to dₘₐₓ passing through this molecule to the target (FIG. 4). Compounds with the highest betweenness represent chemical bottlenecks through which the majority of known syntheses must proceed and should, therefore, be ranked as preferred chemical precursors.

“Redundancy” quantifies the number of synthetic pathways starting at a given compound and terminating at the target (FIG. 4). Compounds with high redundancy can be used as starting materials for several chemical pathways, and this synthetic versatility also makes them preferred candidates as precursors.

“Selectivity” complements betweenness and redundancy. Although a compound may have a high redundancy measure for the synthesis of a specific target, it may also be involved in a large number of other, innocuous syntheses. Consequently, its overall rank as a preferred precursor should be less than that of a compound which is used almost exclusively in the synthesis of a target. The issue may be readily addressed in the context of network topology by examining the local connectivity, i.e. the number of incoming/outgoing reactions, of a precursor compound and/or the ratio of preferred synthetic pathways to non-preferred ones.

In an embodiment of the invention, reverse depth-first searches (DFS) outward from the target compound are run to enumerate all possible pathways (reaction dependencies between compounds are neglected) and to collect betweenness/redundancy statistics of compounds encountered along the way. Selectivity measures are collected by analyzing the local connectivity of the molecules and performing forward DFSs analogous to those above.

The method of the invention provides for the identity of “molecules of interest” not included in Schedules 1 and 2 of Chemical Weapons Convention, e.g., 2,2-diphenyl-2-hydroxyacetic acid methyl ester, which can be used to prepare 3-quinuclidinyl benzilate (BZ).

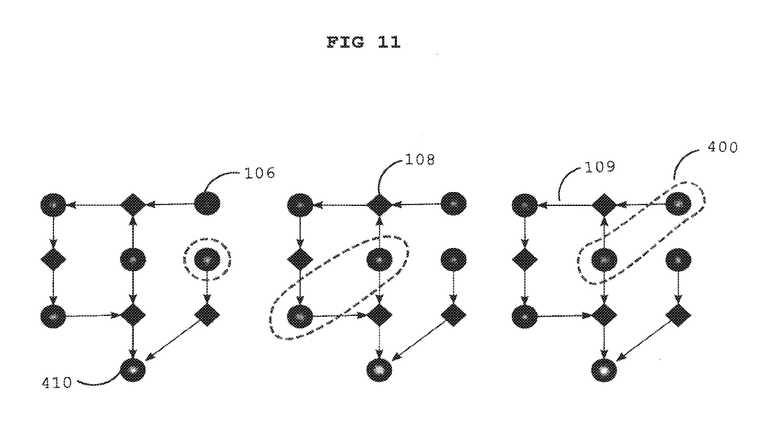

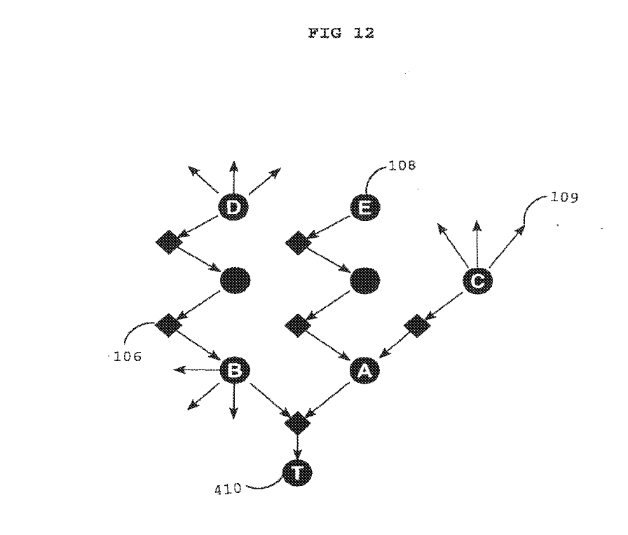

In another embodiment, a combinatorial breadth—first search outward from the target compound is run to identify all minimal sets 400 of precursor compounds 106 (FIG. 11). These minimal sets 400 are then ranked by extended network-topological measures, analogous to the topological network indices for single compounds, namely: set-distance from target, set-betweenness, set-redundancy, and set-selectivity. FIG. 12 gives an example of minimal sets 400 and their topological indices in relation to the production of a compound 410. Assuming target T 410 in FIG. 12 is a chemical weapon, set {C,D} is both well connected (low intent) and is far from the target (low credibility). Set {C,B} is both well connected (low intent) but is close to the target (high credibility). Set {E,D} contains a poorly connected precursor compound (high intent) but is far from the target (low credibility). The highest risk set, {A,B}, contains both a poorly connected compound (high intent) and is close to the target (high credibility).

Thus, in the context that the method of the invention requires the target compound to be a controlled substance such as a narcotic or chemical weapon, the highest ranked sets are most-likely to be used by those wishing to synthesize a narcotic or chemical weapon. In sum, the ability to identify minimal sets is important for (i) regulation of precursors to controlled substances, and (ii) for assessing the intent of an individual. If chemical sales, chemical inventories, purchase orders and the like are monitored using the methods of the invention, the determination of the likelihood of the intent to make a controlled substance is possible, as well as the probability that it will be successfully synthesized.

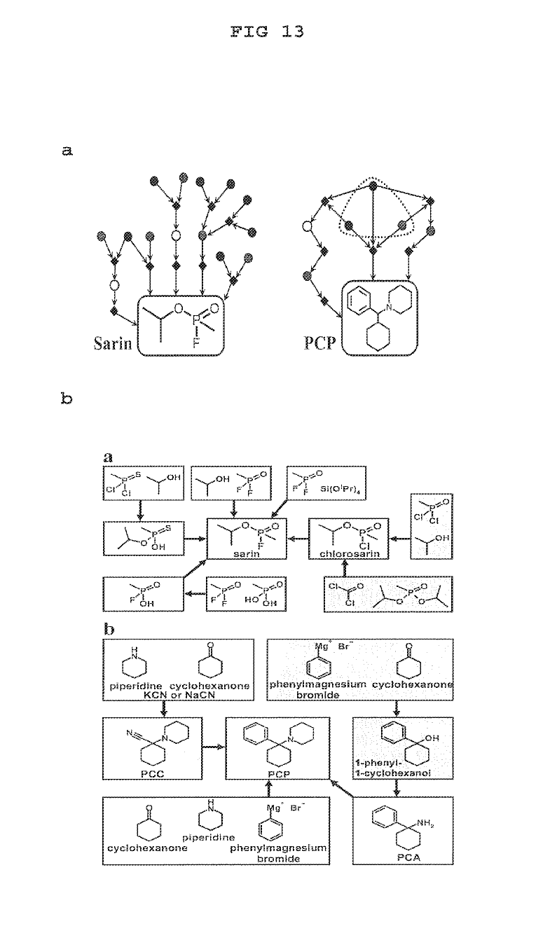

As an example, the method of the invention is performed on sarin, a combinatorial breadth-first search outward from the target compound is run to identify all minimal sets of precursor compounds, as shown in FIG. 11a. In FIG. 13a, sarin and its precursor chlorosarin are restricted by the Department of Homeland Security (DHS) The darker shaded boxes enclose precursor sets also containing restricted substances, while the white boxes surround unrestricted substances which, however, cannot be made without restricted substrates. Unfortunately, both chlorosarin and sarin can be made readily from unrestricted substances via the reactions indicated by the gray boxes. Specifically, chlorosarin can be made in one step from commercially available and unrestricted isopropyl alcohol and methylphosphonic acid dichloroanhydride. Another synthetic route that can evade DHS screening leads from commercially available phosgene and diisopropylmethylphosphonate (DIMP, not commercially available itself but made in one step from commercially available and unrestricted isopropyl alcohol and methylphosphonic acid dichloro anhydride).

In another example, FIG. 13b depicts a subset of the reaction network leading to the anesthetic drug, phencyclidine (PCP) and its nearest precursors, PCC and PCA (red color denotes substances regulated under Schedule II of the Drug Enforcement Agency, DEA). Network analysis identifies three routes to PCP. Two routes require the use of piperidine, which is a monitored substance. Piperidine is a popular synthon in the retrosynthetic analysis of many alkaloids, drugs, and other substances prone to abuse (e.g. morphine, heroin, LSD). Unfortunately, this restriction not only puts extra burden on many well-wishing chemists (piperidine is also a substrate in 16,200 benign reactions), but, also does not prevent the synthesis of PCP by a three step reaction starting from unregulated phenylmagnesium bromide and cyclohexanone.

Thus, a much more efficient regulatory strategy would be to employ the methods of the invention, i.e. monitor the combined inventories of chemical suppliers for the purchases of “red-flag sets” of precursors that signal the intent to make dangerous substances. In the specific PCP example above, the government would be alerted not if one buys piperidine alone, but when an entity acquires at least two out of three key substances (cyclohexanone, piperidine, and Grignard's phenylmagnesium bromide).

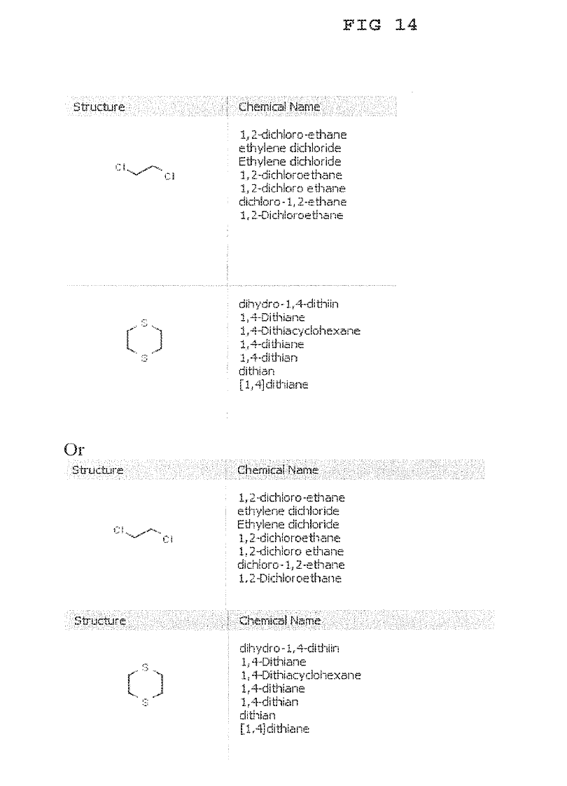

Finally, in still another embodiment of the invention, the minimal-set algorithms are implemented in the form of a friendly user interface that for different types of targets yields CAS numbers that can be then mapped onto the commercial databases of chemical compounds. An example of this capability is illustrated in FIG. 14, which lists one of the minimal sets from which mustard gas can be made, starting from only two commercially available substances.

### Method of Optimizing Multiple Reactions in Parallel

Another embodiment of the invention is a computer-implemented method of economically optimizing multiple reactions in parallel, the method comprising translating a plurality of organic chemical reactions retrieved from a database to a bipartite graph, wherein a first set of nodes of the graph is associated with one or more organic compounds connected by directed edges through a second set of nodes of the bipartite graph associated with one or more reactions; identifying a product or set of products, P from the graph; selecting a set of precursor compounds for the product; determining a connectivity, k, from the graph for each precursor compound; identifying a cost per mole for each precursor, Sᵢ, using, for example, the mathematical formula of the type Sᵢ≅β/√k, wherein √k is the square root of k and is a constant; calculating a total cost function, Cₜₒₜ, using, for example, a mathematical formula of the type Cₜₒₜ=ΣᵢSᵢ+∝N_{r×n}, wherein N_{r×n} represents the total number of reactions and ∝ represents the average cost of performing one reaction; and back-propagating from the product to find optimal precursor compounds.

The method of the invention determines what set of precursors and reaction pathways should an entity use to minimize its overall production cost. Mathematically, this problem is equivalent to finding a set of precursors that minimizes the cost function, Cₜₒₜ, represented as a sum of the costs of reagents and all other labor costs, Cₜₒₜ=C_{subst}+C_{labor}. The link between the formula Cₜₒₜ=Σᵢsᵢ+∝N_{r×n} and the architecture of the network is the correlation between the cost of a precursor and its local network connectivity. Analysis of specific substances (see Angew. Chem. Int. Ed., 2005, 44, 7263; J. Phys. Org. Chem. 2009, 22, 897, incorporated herein by reference) reveals that synthetically popular substances are less expensive than poorly connected ones, with the cost per mole being proportional to the inverse square root of the molecule's network connectivity, Sᵢ≅β/√k, where β is a constant. Using this cost relation, stochastic search algorithms (based on a simulated annealing Monte Carlo optimization. i.e. repeated random sampling) can be back-propagated from the products to find optimal substrates, which minimize the total production costs, Cₜₒₜ. More important are the universal trends that hold for different companies and for different labor costs, as characterized by the dimensionless parameter, χ=∝/β.

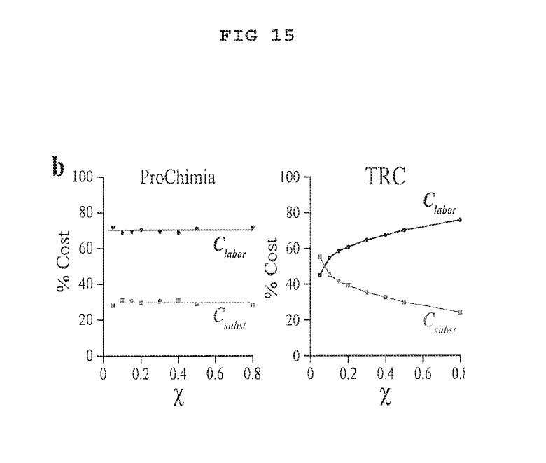

FIG. 15 illustrates the optimization analysis of two chemical companies: ProChimia Poland providing specialized surface modification reagents for self-assembled monolayers (150 products of low average network connectivity) and Toronto Research Chemicals (TRC) offering some 10,000 popular chemicals (average network connectivity 37). For ProChimia's relatively complex and poorly connected products, cheaper precursors are found by increasing the number of synthetic steps. Although using cheaper precursors requires more work to make the products, the optimized pathways are such that the relative overall labor versus precursor costs for the company remain constant (ca. 70% in labor and 30% in substrates) irrespective of the unitary labor cost (FIG. 13b, left). Indeed, the real balance sheet, the labor-to-precursors ratio for years 2001-2008, has remained between 63:37 and 72:28 suggesting that ProChimia manages to operate optimally despite significant changes in labor costs in Poland. For TRC, the division of costs is not expected to be so robust. For this company's relatively simple and well connected products, it is no longer possible to find significantly cheaper substrates by simply expanding the network farther from the products. Thus, as the relative cost of labor decreases, that of precursors increases and ultimately surpasses the former (FIG. 13b, right). This scaling should be characteristic to most large chemical companies, and published reports for Dow Chemical reveal that as much as 80% of their expenditure is in raw materials. The method thus illustrates how chemistry's scale-free architecture, governing the connectivity (and implicitly the costs) of chemical substances can be relevant to the economics of the chemical industry.

### Automatic Identification of Sequential Chemical Reactions

Still another embodiment of the invention is a computer-implemented method of automatically identifying reactions that can be performed sequentially, the method comprising translating a plurality of organic chemical reactions retrieved from a database to a bipartite graph, wherein a first set of nodes of the graph is associated with one or more organic compounds connected by directed edges through a second set of nodes of the bipartite graph associated with one or more reactions; identifying and/or enumerating reaction chains within the graph; eliminating those reaction chains wherein all precursors and reagents involved therein are mutually reactive; eliminating reaction chains wherein precursors are not weekly connected; and, identifying the remaining reaction chains. By “weekly connected” is meant a connectivity that is higher than a given threshold value.

This method of the invention provides for the identity of sequential, one-pot reactions. The method starts with the identification/enumeration of reaction chains of the form A→B→C→ . . . within the network. Of course, not all such chains are compatible with one-pot synthetic procedures. To select those that are, criteria is imposed: (i) that all intermediates and reagents involved in the chain are not mutually reactive, and (ii) that the intermediates are weekly connected (this property eliminates substances that have high synthetic “promiscuity”). These rules allow for the identification of numerous candidate reaction sequences that meet the criteria of chemical orthogonality and for which common reaction conditions exist.

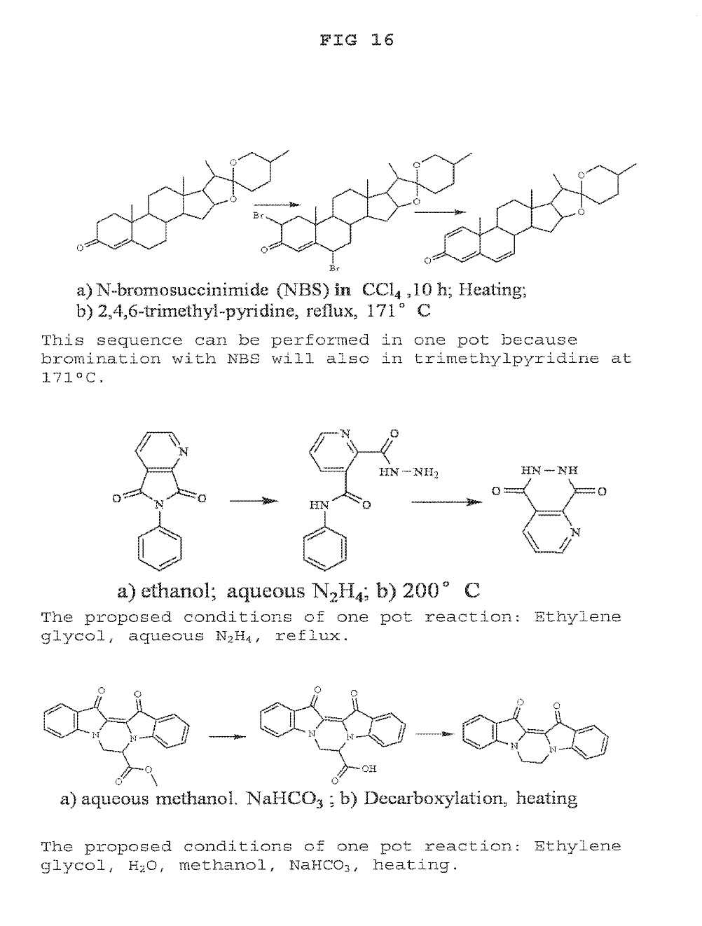

As an example, the two steps in FIG. 16a can be performed in one reaction vessel because the bromination of compound A with NBS yielding compound B will also not affect the elimination of the same in trimethylpyridine at 171° C. to afford compound C. Likewise, the conditions found in FIGS. 14b and 14c, each two step processes, are proposed suitable for one-pot reactions.

Another embodiment of the invention is to provide a computer-readable medium storing instructions that when executed by a computer cause the computer to perform the methods disclosed above. The term computer-readable medium, as used herein, refers to any medium that participates in providing instructions to a processor unit for execution. Such a medium may take many forms, including but not limited to, non-volatile media, and transmission media. Non-volatile media include, for example, optical or magnetic disks, such as storage devices. Volatile media include dynamic memory, such as main memory or random access memory (“RAM”). Common forms of computer-readable media include, for example, floppy disks, flexible disks, hard disks, magnetic tape, punch cards, or any other magnetic medium, a CD-ROM, any other optical medium, punch cards, paper tape, any other physical medium with patterns of holes, a RAM, a PROM, and EPROM, a FLASH-EPROM, and any other memory chip or cartridge, or any other medium from which a computer can read.

It is understood by those skilled in the art that the one or more steps of the application methods of the invention are performed by configuring one or more computer processors to perform such steps. In particular, a computer network can be employed, as in FIG. 2, to perform all necessary functions.

The disclosures of all articles and references, including patents, are incorporated herein by reference.

The invention and the manner and process of making and using it are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention as set forth in the claims.

What is claimed is:

1. A method of economically optimizing synthesis of a product, the method comprising:
a) translating a plurality of organic chemical reactions retrieved from a database to a bipartite graph, wherein a first set of nodes of the graph is associated with a plurality of organic compounds connected by directed edges through a second set of nodes of the bipartite graph associated with one or more reactions;
b) identifying a product, P, from the graph;
c) selecting, from the bipartite graph, a set of precursor compounds for the product;
d) determining a connectivity, k, derived from the bipartite graph for each precursor compound; and
e) calculating a total cost function, Cₜₒₜ, based on substrate cost and labor cost, wherein substrate cost is determined based on the connectivity, k, of each precursor compound and the labor cost is determined based on the total number of reactions performed to synthesize the product, P.

2. The method of claim 1, further comprising repeating steps d)-e) using at least one additional set of precursor compounds for the product.

3. The method of claim 2, wherein the set of precursor compounds with the lowest total cost function is selected as an optimal set.

4. The method of claim 3, wherein the optimal set is shown on a display device.

5. The method of claim 2, wherein the at least one additional set of precursor compounds is selected using Monte Carlo simulation.

6. The method of claim 1, wherein the cost per mole of each precursor compound, Sᵢ, is determined using the mathematical formula Sᵢ≅β/\sqrt{k}, wherein β is a constant.

7. The method of claim 6, wherein the total cost function is determined using a mathematical formula Cₜₒₜ=ΣᵢSᵢ+αN_{r×n} wherein N_{r×n} represents the total number of reactions performed to synthesize the product, P, and α represents the average cost of performing one reaction.

8. A computer program stored in a non-transitory computer readable storage medium, which, when executed by one or more processors, execute the steps of:
a) translating a plurality of organic chemical reactions retrieved from a database to a bipartite graph, wherein a first set of nodes of the graph is associated with a plurality of organic compounds connected by directed edges through a second set of nodes of the bipartite graph associated with one or more reactions;
b) identifying a product, P, from the graph;
c) selecting, from the bipartite graph, a set of precursor compounds for the product;
d) determining a connectivity, k, derived from the bipartite graph for each precursor compound; and
e) calculating a total cost function, Cₜₒₜ, based on substrate cost and labor cost, wherein substrate cost is determined based on the connectivity, k, of each precursor compound and the labor cost is determined based on the total number of reactions performed to synthesize the product, P.

9. The computer program of claim 8, wherein the one or more processors repeat steps d)-e) using at least one additional set of precursor compounds for the product.

10. The computer program of claim 9, wherein the set of precursor compounds with the lowest total cost function is selected as an optimal set.

11. The computer program of claim 10, wherein the optimal set is shown in a display device.

12. The computer program of claim 9, wherein the one or more processors use Monte Carlo simulation to select the at least one additional set of precursor compounds.

13. The computer program of claim 8, wherein the cost per mole of each precursor compound, Sᵢ, is determined using the mathematical formula Sᵢ≅β/\sqrt{k}, wherein β is a constant.

14. The computer program of claim 13, wherein the total cost function is determined using a mathematical formula Cₜₒₜ=ΣᵢSᵢ+αN_{r×n} wherein N_{r×n} represents the total number of reactions performed to synthesize the product, P, and a represents the average cost of performing one reaction.
